(19) United States
(12) Patent Application Publication
(10) Pub. No.: US 2021/0195950 A1
(43) Pub. Date: Jul. 1, 2021

(54) APPARATUS AND METHOD FOR ILLUMINATING VAPOR

(71) Applicant: Mya Johnson, Atlantis, FL (US)

(72) Inventor: Mya Johnson, Atlantis, FL (US)

(21) Appl. No.: 16/728,553

(22) Filed: Dec. 27, 2019

(51) Int. Cl. A24F 40/42; F21V 33/00; A24F 40/53; A24F 40/60

(52) U.S. Cl. CPC A24F 40/42; A24F 40/60; A24F 40/53; F21V 33/0004

(57) ABSTRACT

A vape pen for illuminating vapor includes a base unit defining a rectangular box shape, a charging port at a first end portion of the base unit, and a chamber at a second end portion of the base unit. The chamber is configured for receiving a portion of a pod. A first end portion of the pod has first contacts and is configured to be disposed within the second end portion of the base unit. The base unit is configured to house in electrical communication a central processing unit, a power source, a light emitting element, an actuator for activating the light emitting element, second contacts for engaging the first contact of the pod, and a display. The light emitting element is positioned such that light is emitted from the second end portion of the base unit.

### CROSS-REFERENCE TO RELATED APPLICATIONS

Not applicable.

### STATEMENT REGARDING FEDERALLY SPONSORED RESEARCH OR DEVELOPMENT

Not applicable.

### INCORPORATION BY REFERENCE OF MATERIAL SUBMITTED ON A COMPACT DISC

Not applicable.

### TECHNICAL FIELD

The present invention relates to the field of electronic smoking, and more specifically to the field of electronic cigarettes and personal vaporizers.

### BACKGROUND

The vaping industry has seen an exponential growth over the last five years. According to reliable reports, the industry's worth skyrocketed from $2 billion to $4 billion, from 2013 to 2016, and is expected to grow even further in the coming years. In fact, vaping is no longer just an alternative to smoking—it has become a mode of creative expression. For example, vapers who enjoy blowing large plumes of vapor are known as cloud-chasers. Cloud-chasing is a recreational activity and hobby that integrates technique, air flow, and technology to blow thick clouds of vapor using a vape pen, also known as electronic cigarettes, e-cigarettes, e-cigs, electronic nicotine delivery systems, or vaporizer cigarettes. Cloud-chasing is considered something of an art from and many vapers spend hours practicing and perfecting their technique.

Additionally, cloud-chasing offers an exciting new genre of competition. Some cloud-chasers take part in cloud-blowing contests competing against one another to exhale the largest and most interesting clouds of vapor in front of spectators, known as cloud-gazers. Due to its increasing popularity, cloud-chasers constantly strive to find new ways to create eye-catching effects to differentiate themselves from other cloud-chasers. One way of achieving said endeavor is through the use of lights. For example, cloud-chasers could incorporate lights, especially flashing lights of various colors, to create a unique visual appearance when exhaling large plumes of vapor in front of spectators. At the present moment, however, there are no systems or devices that include a light source for emitting light from vape pens.

Therefore, a need exists to improve over the prior art and more particularly, for a light source that can be integrated into a vape pen to emit light and illuminate vapor proximate to a user's mouth to create a novel and fashionable vaping experience.

### SUMMARY

An apparatus and method for illuminating vapor is disclosed. This Summary is provided to introduce a selection of disclosed concepts in a simplified form that are further described below in the Detailed Description including the drawings provided. This Summary is not intended to identify key features or essential features of the claimed subject matter. Nor is this Summary intended to be used to limit the claimed subject matter's scope.

In one embodiment, a vape pen for illuminating vapor is disclosed. The vape pen includes a base unit defining a rectangular box shape, a charging port at a first end portion of the base unit, and a chamber at a second end portion of the base unit. The chamber is configured for receiving a portion of a pod. A first end portion of the pod has first contacts and is configured to be disposed within the second end portion of the base unit. The base unit is configured to house in electrical communication a central processing unit, a power source, a light emitting element, an actuator for activating the light emitting element, second contacts for engaging the first contact of the pod, and a display. The light emitting element is positioned such that light is emitted from the second end portion of the base unit.

In another embodiment, a method for illuminating vapor is disclosed. The method includes providing a vape pen that includes a base unit defining a rectangular box shape, a charging port at a first end portion of the base unit, and a chamber at a second end portion of the base unit. The chamber is configured for receiving a portion of a pod. A first end portion of the pod has first contacts and is configured to be disposed within the second end portion of the base unit. The base unit is configured to house in electrical communication a central processing unit, a power source, a light emitting element, an actuator for activating the light emitting element, second contacts for engaging the first contact of the pod, and a display. The light emitting element is positioned such that light is emitted from the second end portion of the base unit. The method further includes receiving a first signal to activate the light emitting element and sending a second signal to the actuator to cause light to emanate from the light emitting element.

Additional aspects of the disclosed embodiment will be set forth in part in the description which follows, and in part will be obvious from the description, or may be learned by practice of the disclosed embodiments. The aspects of the disclosed embodiments will be realized and attained by means of the elements and combinations particularly pointed out in the appended claims. It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute part of this specification, illustrate embodiments of the invention and together with the description, serve to explain the principles of the disclosed embodiments. The embodiments illustrated herein are presently preferred, it being understood, however, that the invention is not limited to the precise arrangements and instrumentalities shown, wherein:

FIG. 1 is an exploded perspective view of a vape pen for illuminating vapor, according to an example embodiment of the present invention:

FIG. 2A is a front perspective view of an assembled base unit, according to an example embodiment of the present invention;

FIG. 2B is a front view of an assembled base unit, according to an example embodiment of the present invention;

FIG. 2C is a rear view of an assembled base unit, according to an example embodiment of the present invention;

FIG. 2D is a right-side view of an assembled base unit, according to an example embodiment of the present invention;

FIG. 2E is a left-side view of an assembled base unit, according to an example embodiment of the present invention;

FIG. 2F is a top view of an assembled base unit, according to an example embodiment of the present invention;

FIG. 2G is a bottom view of an assembled base unit, according to an example embodiment of the present invention;

FIG. 3 is a partially exploded rear view of a central processing unit, a power source, and a light emitting element, according to an example embodiment of the present invention;

FIG. 4 is a rear view of a central processing unit and a light emitting element connected to a power source, according to an example embodiment of the present invention;

FIG. 5 is a partially exploded rear view of a base unit and a central processing unit and a light emitting element connected to a power source, according to an example embodiment of the present invention;

FIG. 6 is a rear perspective view of a central processing unit and a light emitting element connected to a power source, wherein the central processing unit, the light emitting element, and the power source are positioned inside a base unit, according to an example embodiment of the present invention;

FIG. 7 is a partially exploded rear perspective view of an end cap and a central processing unit and power source positioned inside a base unit, according to an example embodiment of the present invention;

FIG. 8 is a rear perspective view of an end cap attached to a pair of second contacts inside a base unit, according to an example embodiment of the present invention;

FIG. 9 is a partially exploded rear perspective view of a first internal cover and a base unit, wherein a central processing unit, a light emitting element, and a power source are positioned inside the base unit, and an end cap is attached to a pair of second contacts inside the base unit; according to an example embodiment of the present invention;

FIG. 10 is a rear perspective view of a first internal cover positioned inside a base unit, according to an example embodiment of the present invention;

FIG. 11 is a partially exploded rear perspective view of a second internal cover and a base unit, according to an example embodiment of the present invention;

FIG. 12 is a rear perspective view of a second internal cover positioned inside a base unit, according to an example embodiment of the present invention;

FIG. 13 is a partially exploded rear perspective view of a first external cover and a base unit, according to an example embodiment of the present invention;

FIG. 14 is a rear perspective view of a first external cover attached to a base unit, according to an example embodiment of the present invention:

FIG. 15 is a partially exploded front perspective view of a third internal cover and a base unit, according to an example embodiment of the present invention;

FIG. 16 is a front perspective view of a third internal cover attached to a base unit, according to an example embodiment of the present invention;

FIG. 17 is a partially exploded front perspective view of an actuator for activating a light emitting element and a base unit, according to an example embodiment of the present invention;

FIG. 18 is a front perspective view of an actuator for activating a light emitting element attached to a contact block inside a base unit, according to an example embodiment of the present invention;

FIG. 19 is a partially exploded front perspective view of a second external cover and a base unit, according to an example embodiment of the present invention;

FIG. 20 is a front perspective view of a second external cover attached to a base unit, according to an example embodiment of the present invention:

FIG. 21 is a partially exploded front perspective view of a display cover and a base unit, according to an example embodiment of the present invention;

FIG. 22 is a front perspective view of a display cover attached to a base unit, according to an example embodiment of the present invention;

FIG. 23 is a partially exploded side perspective view of a light emitting element cover and a base unit, according to an example embodiment of the present invention:

FIG. 24 is a side perspective view of a light emitting element cover attached to a base unit, according to an example embodiment of the present invention:

FIG. 25A is a front view of a pod configured to be disposed within a base unit, according to an example embodiment of the present invention:

FIG. 25B is a side view of a pod configured to be disposed within a base unit, according to an example embodiment of the present invention:

FIG. 25C is a bottom view of a pod configured to be disposed within a base unit, according to an example embodiment of the present invention;

FIG. 25D is a front sectional view of the interior components of a pod configured to be disposed within a base unit, according to an example embodiment of the present invention;

FIG. 25E is a side sectional view of the interior components of a pod configured to be disposed within a base unit, according to an example embodiment of the present invention:

FIG. 25F is a front cross-sectional view of the interior components of a pod configured to be disposed within a base unit, according to an example embodiment of the present invention;

FIG. 25G is a side cross-sectional view of the interior components of a pod configured to be disposed within a base unit, according to an example embodiment of the present invention;

FIG. 26 is a partially exploded perspective view of a coil unit and a silicone ring, according to an example embodiment of the present invention;

FIG. 27 is a perspective view of a silicone ring positioned on a coil unit, according to an example embodiment of the present invention;

FIG. 28 is a perspective view of a heating element coiled around a wick, according to an example embodiment of the present invention:

FIG. 29 is a perspective view of a heating element coiled around a wick and positioned on a coil unit, according to an example embodiment of the present invention;

FIG. 30 is a partially exploded perspective view of a coil unit and a pair of silicone sleeves, according to an example embodiment of the present invention;

FIG. 31 is a partially exploded perspective view of a coil unit and a pair of first conductors, according to an example embodiment of the present invention;

FIG. 32 is a perspective view of a coil unit, wherein a pair of silicone sleeves and a pair of first conductors are positioned inside the coil unit, according to an example embodiment of the present invention;

FIG. 33 is a partially exploded perspective view of a mouth that is configured to attach to a first end of a coil unit, according to an example embodiment of the present invention;

FIG. 34 is a perspective view of an assembled coil unit, according to an example embodiment of the present invention;

FIG. 35 is a partially exploded perspective view of a tube and a pod configured to be disposed within a base unit, according to an example embodiment of the present invention;

FIG. 36 is a cross-sectional view of a tube disposed within a pod configured to be disposed within a base unit, according to an example embodiment of the present invention;

FIG. 37 is a partially exploded perspective view of a coil unit and a pod configured to be disposed within a base unit, according to an example embodiment of the present invention;

FIG. 38 is a cross-sectional view of a coil unit disposed within a pod configured to be disposed within a base unit, according to an example embodiment of the present invention;

FIG. 39 is a partially exploded perspective view of a sealing cap and a pod configured to be disposed within a base unit, according to an example embodiment of the present invention;

FIG. 40 is a perspective view of a pod sealing cap attached to a first end portion of a pod configured to be disposed within a base unit, according to an example embodiment of the present invention;

FIG. 41 is a partially exploded perspective view of a mouthpiece and a pod configured to be disposed within a base unit, according to an example embodiment of the present invention:

FIG. 42 is a perspective view of a mouthpiece attached to a first end portion of a pod configured to be disposed within a base unit, according to an example embodiment of the present invention;

FIG. 43 is a partially exploded perspective view of a mouthpiece cover and a mouthpiece attached to a first end portion of a pod configured to be disposed within a base unit, according to an example embodiment of the present invention;

FIG. 44 is a perspective view of a mouthpiece cover attached on a mouthpiece, according to an example embodiment of the present invention;

FIG. 45 is a partially exploded perspective view of a pod cover and a pod configured to be disposed within a base unit, according to an example embodiment of the present invention;

FIG. 46 is a perspective view of a pod configured to be disposed within a base unit, wherein a mouthpiece cover and a pod cover are attached to the pod, according to an example embodiment of the present invention;

FIG. 47 is a perspective view of a base unit and a pod configured to be disposed within a base unit, wherein a mouthpiece cover and a pod cover are attached to the pod, according to an example embodiment of the present invention;

FIG. 48 is a perspective view of a pod being inserted into a chamber located on a second end portion of a base unit, according to an example embodiment of the present invention;

FIG. 49A is a perspective view of an assembled vape pen for illuminating vapor, according to an example embodiment of the present invention;

FIG. 49B is a front view of an assembled vape pen for illuminating vapor, according to an example embodiment of the present invention;

FIG. 49C is a rear view of an assembled vape pen for illuminating vapor, according to an example embodiment of the present invention;

FIG. 49D is a right-side view of an assembled vape pen for illuminating vapor, according to an example embodiment of the present invention;

FIG. 49E is a left-side view of an assembled vape pen for illuminating vapor, according to an example embodiment of the present invention;

FIG. 49F is a top view of an assembled vape pen for illuminating vapor, according to an example embodiment of the present invention;

FIG. 49G is a bottom view of an assembled vape pen for illuminating vapor, according to an example embodiment of the present invention;

FIG. 50A is a front cross-sectional view of an airflow path for a vape pen for illuminating vapor, according to an example embodiment of the present invention;

FIG. 50B is a side cross-sectional side view of an airflow path for a vape pen for illuminating vapor, according to an example embodiment of the present invention;

FIG. 50C is a cross-sectional bottom view of a coil unit passageway opening located within a coil unit, according to an example embodiment of the present invention:

FIG. 51 is a block diagram showing the main components of a vape pen for illuminating vapor, according to an example embodiment of the present invention; and

FIG. 52 is a flowchart describing the steps of the process for illuminating vapor, according to an example embodiment of the present invention.

### DETAILED DESCRIPTION

The following detailed description refers to the accompanying drawings. Whenever possible, the same reference numbers are used in the drawings and the following description to refer to the same or similar elements. While disclosed embodiments may be described, modifications, adaptations, and other implementations are possible. For example, substitutions, additions or modifications may be made to the elements illustrated in the drawings, and the methods described herein may be modified by substituting reordering or adding additional stages or components to the disclosed methods and devices. Accordingly, the following detailed description does not limit the disclosed embodiments. Instead, the proper scope of the disclosed embodiments is defined by the appended claims.

The present invention improves upon the prior art by providing a vape pen for illuminating vapor. The vape pen includes an actuator for activating a light emitting element such that light is emitted from a second end portion of a base unit. The light emitting element is configured to emit at least one of a color and shade of light to illuminate vapor proximate a user's mouth when in use by the user.

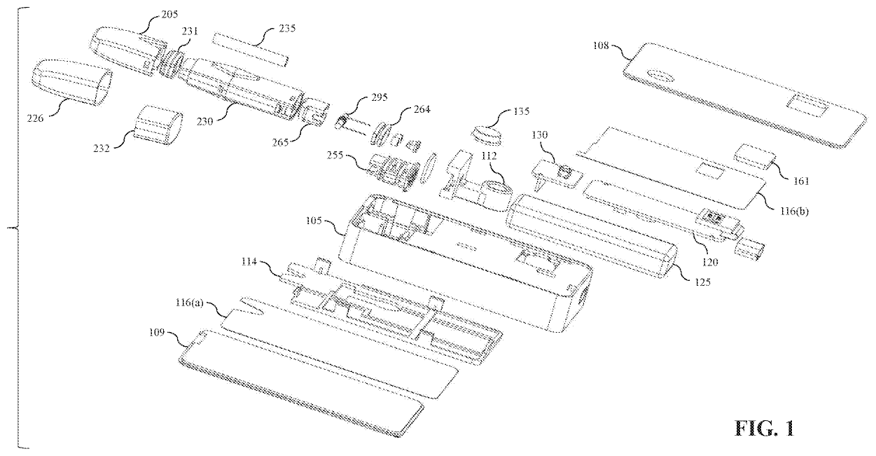

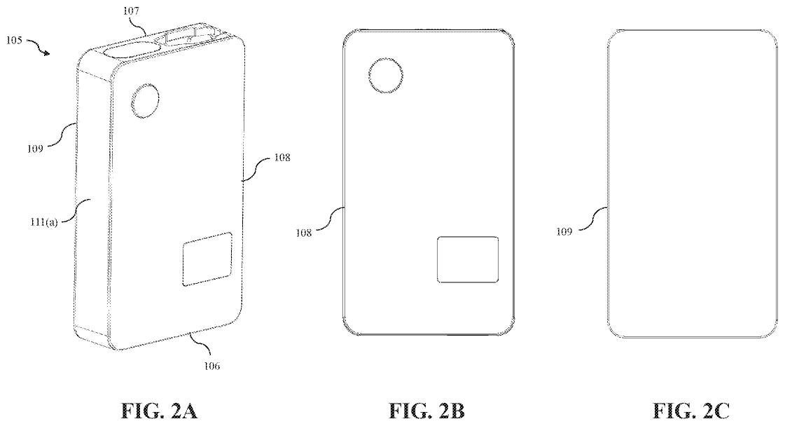

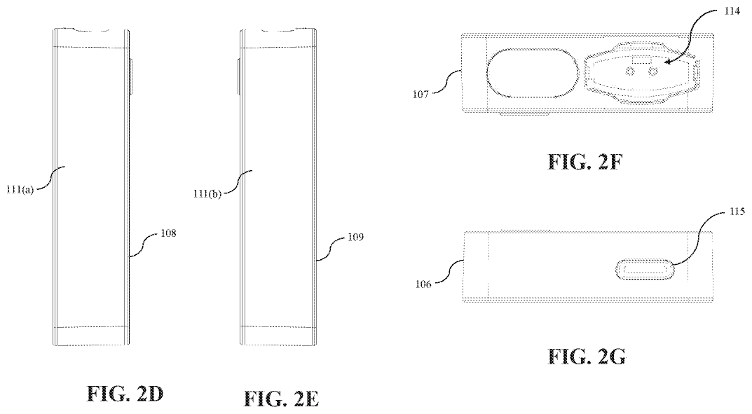

Referring now to the Figures, FIG. 1 is an exploded perspective view of a vape pen 100 for illuminating vapor, according to an example embodiment of the present invention. The vape pen 100 includes a base unit 105 defining a rectangular box shape. The base unit 105 includes an integrally formed inner frame structure 113 and a corresponding inner frame cover 114 that is configured to securely house in electrical communication a central processing unit 120, a power source 125, a light emitting element 130, an actuator 135 for activating the light emitting element 130, a second pair of contacts 140 for engaging a first pair of contacts 290 of a pod 200, and a display 160. As illustrated in FIGS. 2A-2G, the base unit further includes a first end portion 106, a second end portion 107, a frontward facing surface 108, a rearward facing surface 109, and two opposing sidewalls 111(a), 111(b). The frontward facing surface 108 and the rearward facing surface 109 are configured to prevent dirt and debris from entering into the base unit and to increase the durability and general life span of the base unit. The base unit may have other shapes and dimensions, and such variations are within the spirit and scope of the claimed invention. The base unit 105 may be comprised of materials such as metals, alloys, plastics or composite materials containing one or more of those materials, and thermoplastics.

In the present embodiment, the frontward facing surface 108 and the rearward facing surface 109 are attached to the base unit with a waterproof adhesive 116(a), 116(b), however, it should also be appreciated that other attachment devices may be used, including screws, bolts, welds, pins, clamps, brackets, magnets, male-female interference-type connections, cable ties, or any other suitable method known in the art. It should be appreciated that the frontward facing surface 108 and the rearward facing surface 109 may be interchanged and may take additional forms, textures, ridges, and dimensions. The frontward facing surface 108 and the rearward facing surface 109 may be formed from the same material as the base unit, or they may be formed from any other suitable material.

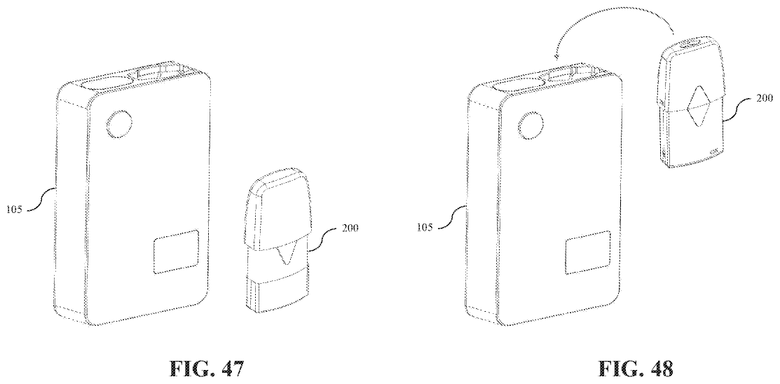

The vape pen 100 includes a chamber 114 at the second end portion 107 of the base unit. As discussed below, the chamber is configured for receiving a portion of the pod 200. In the present embodiment, the chamber 114 has an elongated oval shaped opening that is sized and shaped according to the outer circumference of the pod 200. In operation, as best illustrated in FIGS. 47-49, the chamber receives and maintains a first end portion of the pod 200 in a stationary position such that the second pair of contacts 140 of the base unit 105 engage the first pair of contacts 290 of the pod 200. It should be appreciated that the chamber may have a variety of cross-sectional shapes and configurations and can be manufactured from a variety of different processes such as punching, stamping, scissoring, flame cutting, laser cutting, sawing, drilling, milling, or turning.

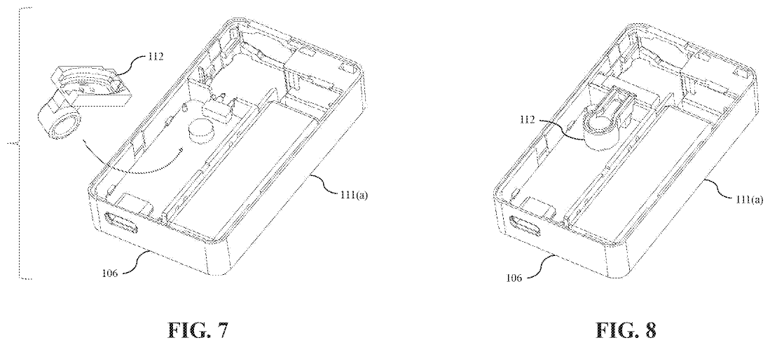

As illustrated in FIGS. 7 and 8, a sealing cap 112 is located below the chamber on the inside of base unit. The sealing cap is configured to prevent dirt and debris from entering the internal components of the base unit. In the present embodiment, the sealing cap 112 is a silicone end cap comprising a hollow rectangular shaped body that is sized to fit snugly inside the base unit 105. It should be appreciated that the sealing cap 112 may take additional forms, textures, ridges, and dimensions and may be formed from other suitable materials.

The vape pen 100 also includes a charging port 115 at the first end portion 106 of the base unit 105. The charging port 115 is configured to recharge the power source 125 housed within the base unit 105. In the present embodiment, the charging port 115 is a USB charging port, however, other types of ports may be used to recharge the power source. The power source 125 is a rechargeable lithium battery due to its high voltage and high charge density. It should be appreciated that other types of rechargeable batteries, such as nickel metal hydride (NiMH) or multiple batteries and/or battery types could be used in the vape pen 100, with the charging functionality then optimized for those battery configurations.

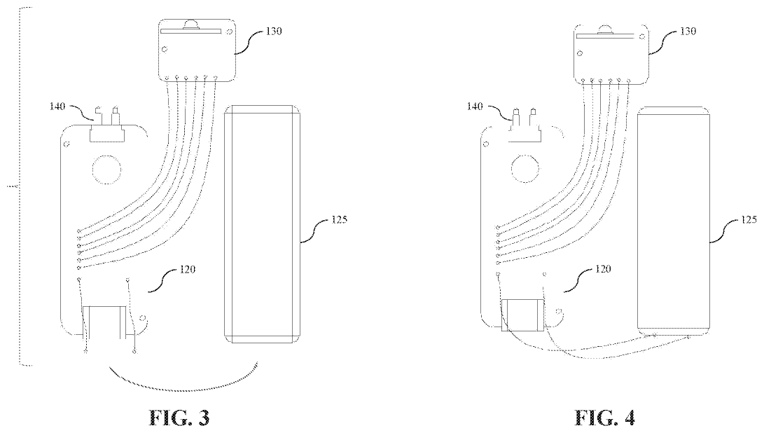

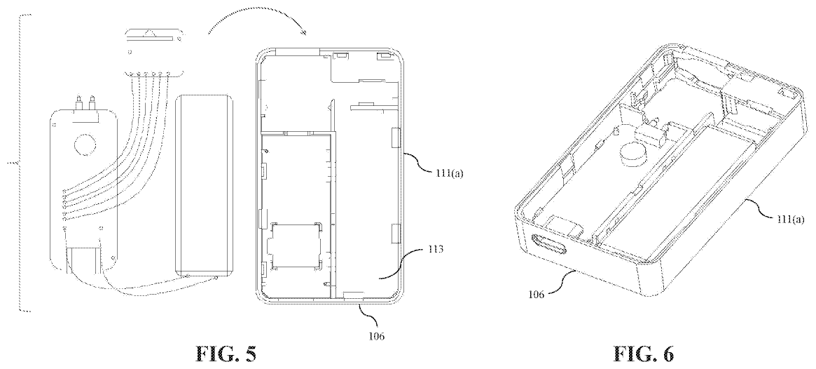

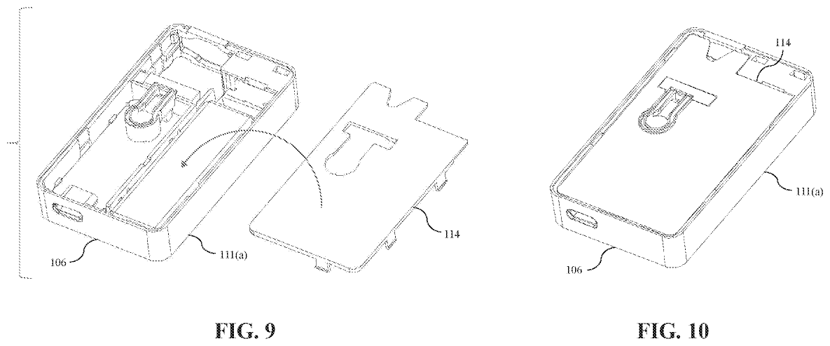

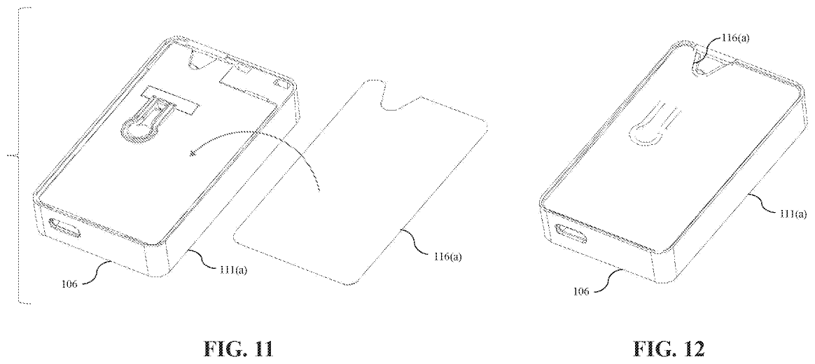

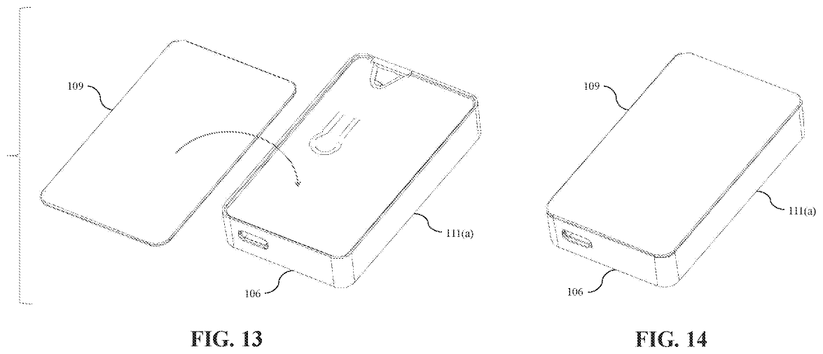

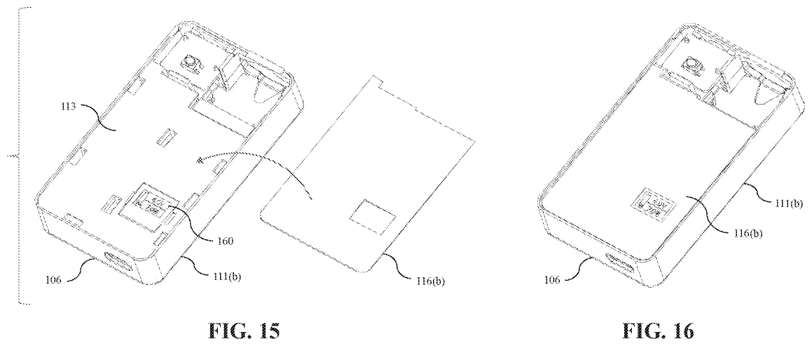

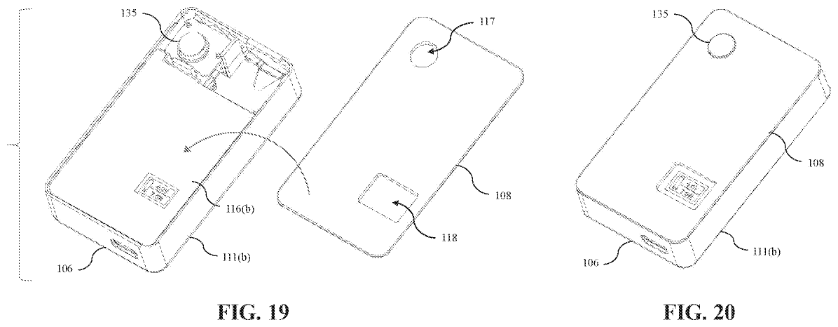

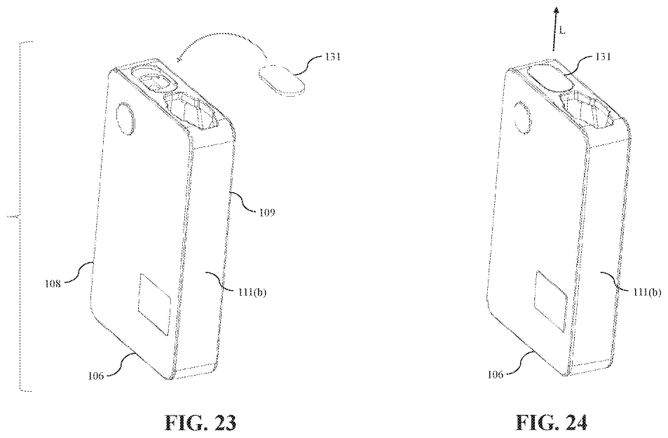

FIGS. 3-24 illustrate the assembly sequence of the base unit 105 and will be discussed together for ease of reference. The vape pen 100 includes the central processing unit 120 containing the operating logic for the vape pen 100. As best illustrated in FIGS. 3 and 4, the central processing unit 120 is housed inside the base unit and conductively and communicatively coupled with the power source 125, the light emitting element 130, the actuator 135 for activating the light emitting element 130, the second contacts 140 for engaging the first contacts of the pod 155, and the display 160.

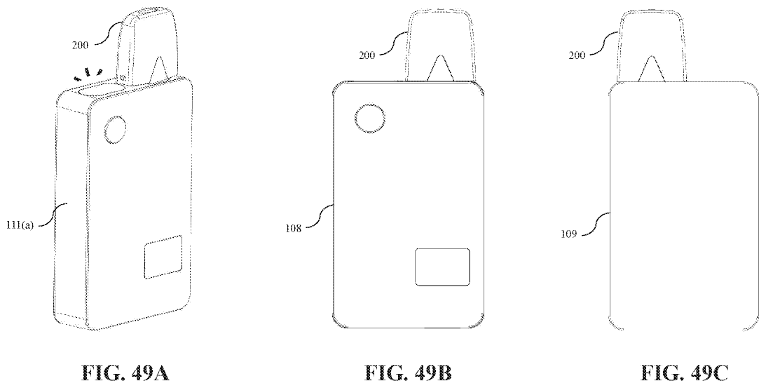

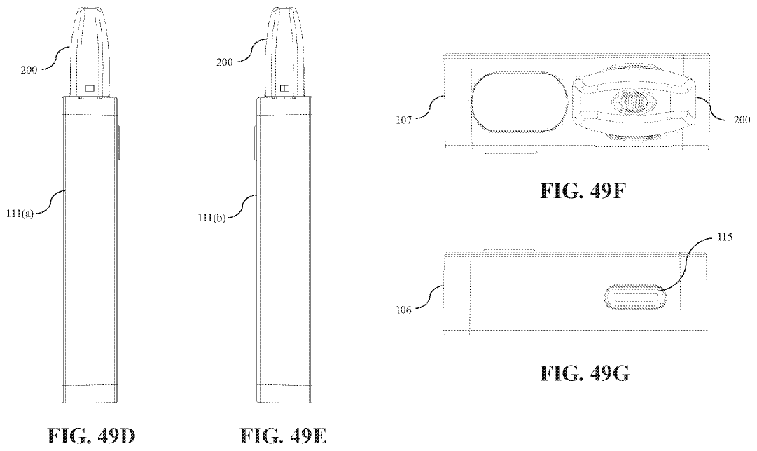

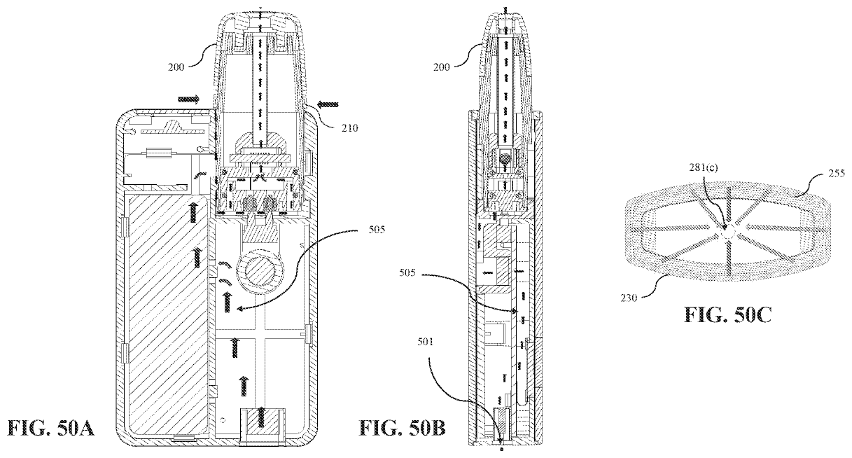

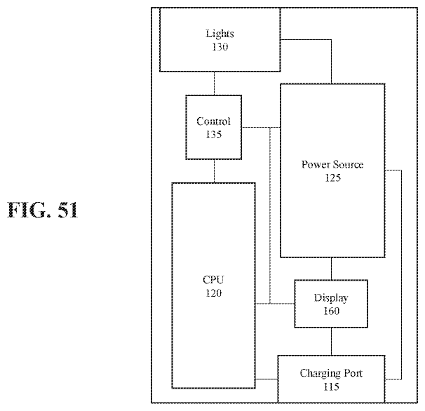

The light emitting element 130 is housed inside the base unit 105. The light emitting element 130 is configured to emit at least one of a color and shade of light from the base unit. Exemplary color-changing lights include RGB LEDs, bi-color LEDs, flashing LEDs, digital RGB LEDs, (organic) OLEDs, and RGB WLEDs (White LEDs). In operation, the light emitting element is configured to emit light to illuminate vapor proximate a user's mouth to create a novel and fashionable vaping experience. In the present embodiment, the light emitting element 130 and a light emitting element cover 131 are positioned proximate to the chamber 114 such that light is emitted from the second end portion 107 of the base unit 105. It should be appreciated that a plurality of light emitting elements of the same or different colors may be used to create a more intense light. For example, the light emitting element may function as a flashlight or key-hole finder in dark environments. Further, a plurality of light emitting elements may be clustered together inside of the base unit or may be evenly or randomly distributed throughout. For example, a light emitting element may be located on the first portion of the base unit to indicate the charge state of the power source (e.g. fully discharged, low, medium, high, or fully charged) by flashing the light emitting element in different colors or patterns, and such variations within the spirit and scope of the present invention. In one embodiment, light may be emitted in approximately the direction of arrowed Line L. It is understand that when a consumer hold the device while smoking the position of the light emitting element being positioned such that light is emitted from the second end portion of the base unit allows the user to illuminate vapor that is emitted from the user's lungs to create a novel and fashionable vaping experience. Additionally, the box shape is unique in that it allows air to be drawn in from an inlet 501 on the first end portion 106 of the base. FIGS. 50A-50C illustrate the flow of air through the inlet portion of the base section and ultimately to the heating chamber. FIGS. 50A and 50B illustrate that air enters into the inlet from the first end portion of the base section and travels through air passageways 505 within the base unit and ultimately into the heating chamber. This configuration also allows to have air traveling through the first end of the base unit but also allows the light emitting element to emit light from the first end of the base unit (see FIGS. 24 and 49A) and which provides for better illumination of the vapor that is emitted from the user's lungs when the user exhales vapor from the user's lungs that have been inhaled into the user's lungs. It is also understood that there is a potential for the air passageways of the base section to provide for an increased user vaping experience.

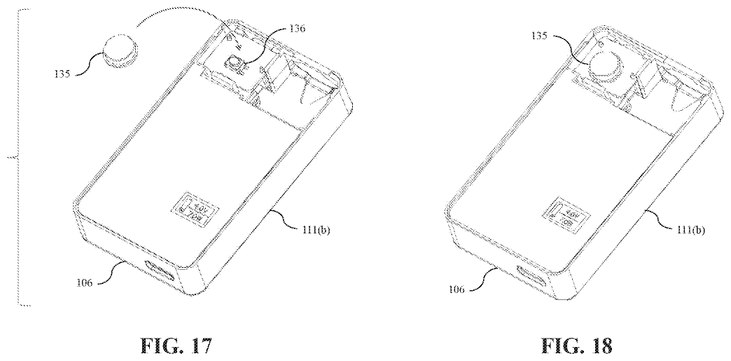

The actuator 135 is configured to allow the user to control how the various functions of the light emitting element are performed. For example, in one embodiment, the actuator 135 may be depressed or pushed a predetermined number of times to adjust the light color, color-change sequence, color selection, color-change transition effects (fast fade, slow fade, etc.), color-change duration or speed, and flashing or strobe effects of the light emitting element. It should be appreciated that other patterns and lighting options are possible without departing from the scope of the current invention. The actuator 135 is also configured such that the user may adjust the voltage such that a plurality of liquid vaporizing material may be vaporized. In the present embodiment, as best illustrated in FIGS. 17 and 18, the actuator 135 is a push-button secured to a contact block 136 positioned inside of the base unit, near the second end portion 107. The actuator protrudes outward through a first cutout 117 on the frontward facing surface 108 of the base unit 105.

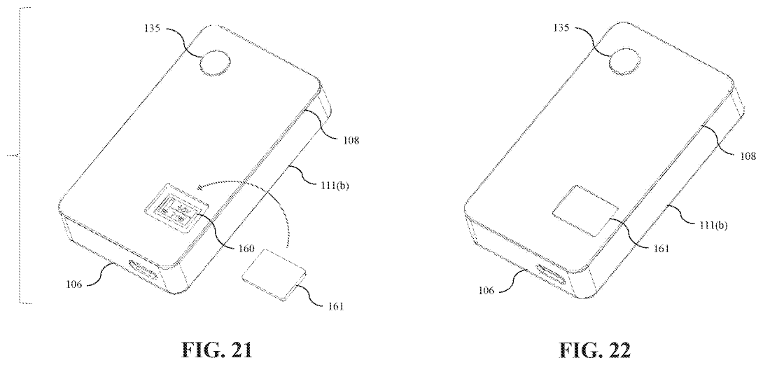

The display 160 is configured to display a graphical representation of at least the various functions of the light emitting element, an amount of charge in the power source, and a voltage at which power is provided from the power source. In the present embodiment, as best illustrated in FIGS. 21 and 22, the display is positioned on the inside of the base unit, near the first end portion 106. A display cover 161 is positioned inside of a second cutout 118 on the frontward facing surface 106 of the base unit 105 such that the display cover is flush with the frontward facing surface of the base unit.

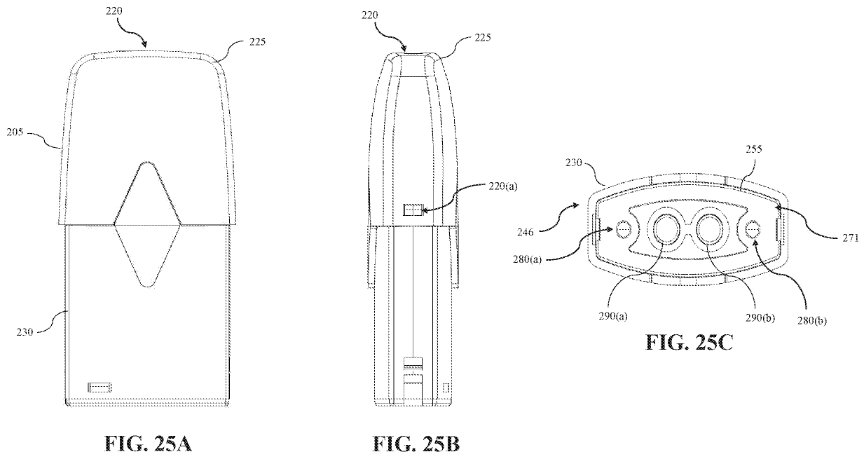

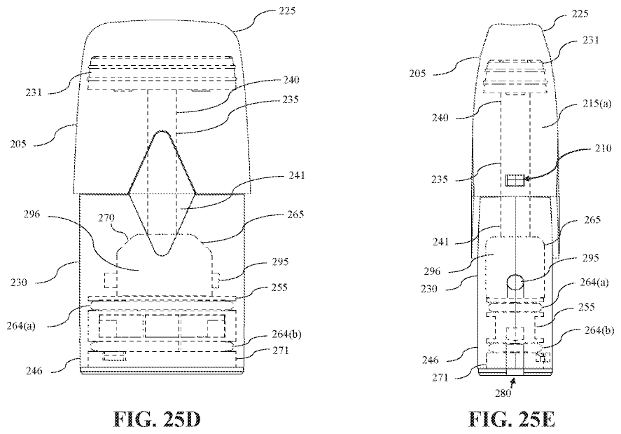

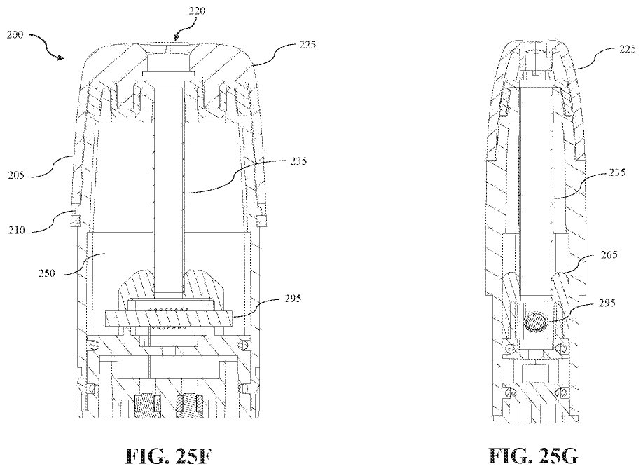

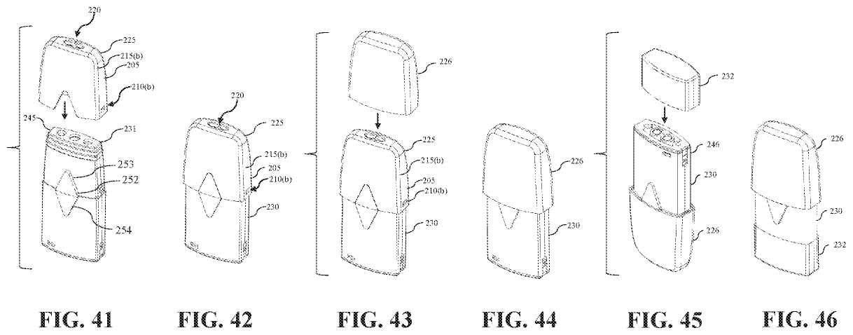

FIGS. 25-46 illustrate the assembly sequence of the pod 200 and will be discussed together for ease of reference. The pod 200 includes a mouthpiece 205 comprising a hollow rectangular shaped body with a frontward facing side 206, a rearward facing side 207, two opposing sidewalls 215(a), 215(b), an end wall 208, and a central opening 209 located on a bottom end 211 of the mouthpiece 205. The mouthpiece 105 is the part of the pod 200 from which the user places to their mouth to inhale vapor. The mouthpiece 205 includes at least one mouthpiece inlet 210(a), 210(b) on the mouthpiece sidewall 215(a), 215(b), and an air outlet 220 at a mouthpiece end 225. The at least one mouthpiece inlet 210(a), 210(b) is configured to increase the flow of air through the pod to produce smoother flavor and increased vapor production. In operation, when the user draws from the air outlet 220 of the mouthpiece 205, air flows from an outside environment through the at least one mouthpiece inlet 210(a), 210(b), through at least one coil unit passageway 280 and to a tube 235, as will be discussed. A draw is a term used to refer to the inhalation of vapor from the mouthpiece 205. When there is an increase of air flowing through a coil unit, the vapor gets less dense and produces large clouds of vapor. Due to the highly dense water content in vapor, the vapor that is exhaled by the user is often referred to as clouds. This also means that because the vapor is less concentrated, the impact of the vapor on the user's throat is reduced, thereby providing a smoother taste. In addition, the increase of air flowing through the base unit 100 produces cooler vapor and offers a much looser, airier draw, like sucking on a wide straw.

In the present embodiment, the mouthpiece 205 contains one mouthpiece inlet 210(a), 210(b) on the bottom end 211 of each sidewall 215(a), 215(b). Each mouthpiece inlet 210(a), 210(b) has a rectangular shaped opening with a predetermined length and width. It should be appreciated that the mouthpiece inlet can have a variety of cross-sectional shapes and configurations and can be manufactured from a variety of different processes such as punching, stamping, scissoring, flame cutting, laser cutting, sawing, drilling, milling, or turning. The mouthpiece 205 may be comprised of any suitable material or combination of materials. Examples of suitable materials include metals, alloys, plastics or composite materials containing one or more of those materials, or thermoplastics that are suitable for food or pharmaceutical applications, for example polypropylene, polyetheretherketone (PEEK), ceramic, and polyethylene.

In one embodiment, as illustrated in FIGS. 43-44, the mouthpiece 205 includes a mouthpiece cover 226 that is configured to prevent dirt and debris from entering into the air outlet 220 located on the mouthpiece end 225 and to increase the durability and general life span of the mouthpiece 205. In the present embodiment, the mouthpiece cover is made of silicone and comprises a hollow square shaped body that is sized to fit snugly around the mouthpiece. It should be appreciated that the mouthpiece cover may be interchanged and may take additional forms, textures, ridges, and dimensions, and may be comprised of rubber materials such as neoprene, nitrile, and urethanes. The mouthpiece cover 226 can be manufactured from a variety of different processes such as injection molding, compression molding, and transfer molding.

The pod includes a first housing 230 configured to removably attach to the mouthpiece 205. The first housing 230 comprises a hollow rectangular shaped body with a frontward facing side 231, a rearward facing side 233, two opposing sidewalls 234(a), 234(b), a first end 245, and a second end 246. However, shapes may also be used and are within the spirit and scope of the present invention. The first housing may be formed from the same material as the mouthpiece 205 or may be formed from another suitable material. In the present embodiment, the first housing includes a detent member 249(a), 249(b) located near the first end 245 of each sidewall 234(a), 234(b). Each detent member is configured to engage each mouthpiece inlet 210(a), 210(b) located on the bottom end 211 of each mouthpiece sidewall 215(a), 215(b).

The first housing 230 further includes a detent opening 251(a), 251(b) located near the second end 246 of each sidewall 234(a), 234(b). Each detent opening is configured to receive a second housing detent member (not shown) located inside the chamber of the base unit. It should be appreciated that other attachment devices can be used to removably or permanently attach the mouthpiece to the first housing, including screws, bolts, welds, pins, clamps, brackets, magnets, male-female interference-type connections, waterproof adhesives, or any other suitable method known in the art.

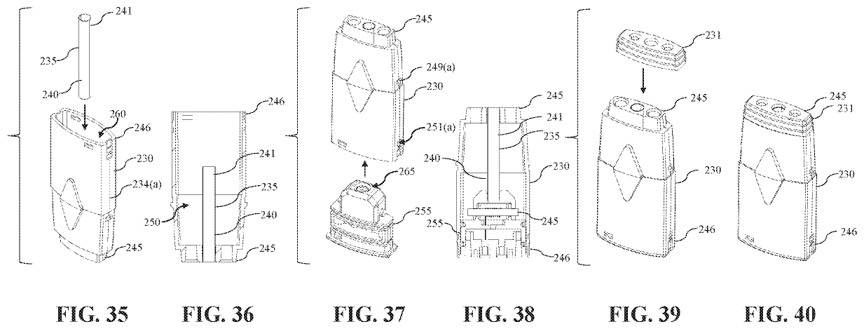

As shown in FIGS. 35 and 36, a tube 235 is disposed within the first housing of the pod 200. The tube has a hollow cylindrical shaped body comprising a first end 240 and a second end 241. The tube is configured such that the first end 240 of the tube is proximate to a first end 245 of the first housing 230, and the second end of the tube is proximate to a first end 270 of the coil unit 255. It should be appreciated that the tube can have a variety of cross-sectional shapes and configurations and may be formed from the same material as the pod or may be formed from another suitable material.

An oil chamber 250 is located within the first housing 230 of the pod 200. The oil chamber is configured for storing liquid vaporizing material. Liquid vaporizing material typically contains vegetable glycerin, propylene glycol, nicotine and flavoring. Alternatively, or in addition, liquid vaporizing material may include a nontobacco material. For example, liquid vaporizing material may include water, oils, solvents, ethanol, plant extracts and natural or artificial flavors. As best illustrated in FIGS. 39 and 40, a first housing 230 sealing cap 231 attaches to the first end 245 of the first housing 230. When the vape pen 100 is in the fully assembled configuration, the pod sealing cap 231 prevents liquid vaporizing material within the oil chamber 250 from exiting the first end of the first housing 230.

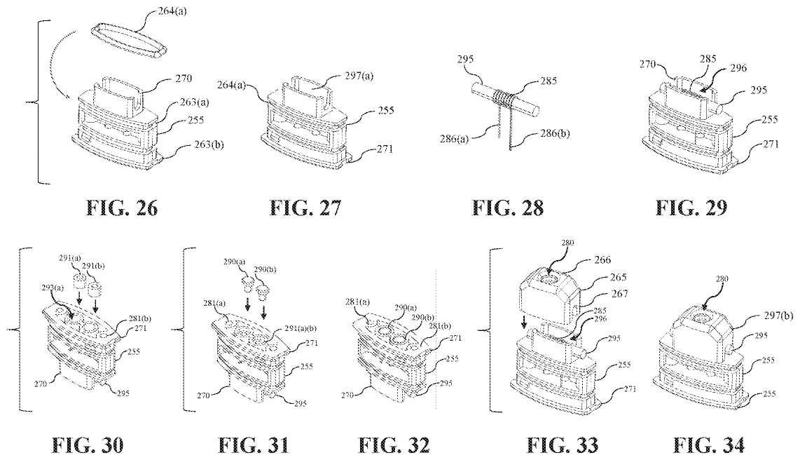

FIGS. 26-34 illustrate the assembly sequence of the coil unit and will be discussed together for ease of reference. The coil unit 255 is configured to be removably attachable within a coil unit compartment 260 of the first housing 230. In the present embodiment, the coil unit has a hollow rectangular shaped body comprising a first end 270 and a second end 271. The first end of the coil unit includes a first part 297(a) of a heating chamber 296, as will be discussed. It should be appreciated that the coil unit may take additional forms and dimensions and may be formed from the same material as the first housing or may be formed from another suitable material.

The coil unit employs a sliding fit sealed by a pair of silicone rings 264(a), 264(b) such that the coil unit can be easily fitted or removed from the coil unit compartment 260 of the first housing 230. The silicone rings 264(a). 264(b) are wrapped around a pair of circumferential outer grooves 263(a), 263(b) located on an exterior surface of the coil unit. It should be appreciated that the silicone rings may be interchanged and may take additional forms, textures, ridges, and dimensions, and may be formed from nitrile or other synthetic rubber-like materials. In another embodiment, the coil unit is permanently attached to the coil unit compartment of the first housing 230.

As illustrated in FIGS. 33 and 34, a mouth 265 is located at the first end 270 of the coil unit 255. The mouth 265 of the coil unit is configured for receiving the second end 241 of the tube 235 such that vapor, and air can pass through the mouth and into the tube when the vape pen 100 is in the fully assembled configuration. In the present embodiment, the mouth comprises a hollow rectangular shaped body having a top end 266 and a bottom end 267. The top end of the mouth includes a circular shaped opening 280 that is configured for receiving the second end 241 of the tube 235. The bottom end of the mouth 265 includes a second part 297(b) of the heating chamber 296. The heating chamber houses a heating element and a wick, such that when heated produces vapor, as will be discussed. It should be appreciated that the mouth may be interchanged and may take additional forms, textures, ridges, and dimensions, and may be formed from nitrile or other synthetic rubber-like materials.

At least one coil unit passageway 280(a), 280(b) is located within the coil unit. In the present embodiment, the coil unit includes two coil unit passageways, each comprising a circular shaped opening 281(a), 281(b) and a vertical air passage 282(a), 282(b). Each vertical air passage which opens into an interior of the coil unit that defines a central channel 283. As best illustrated in FIG. 50C, the central channel 283 comprises a third opening 281(c) that is configured to allow air to flow inside the heating chamber. When there is an increase of air flowing through the coil unit, the vapor gets less dense and produces large clouds of vapor. This also means that because the vapor is less concentrated, the impact of the vapor on the user's throat is reduced, thereby providing a smoother taste. In addition, the increase of air flowing through the vape pen 100 produces cooler vapor and offers a much looser, airier draw, like sucking on a wide straw.

A heating element 285 is located near the first end 270 of the coil unit 255. The heating element is configured to vaporize the liquid vaporizing material inside the oil chamber 250. In the present embodiment, as illustrated in FIGS. 28 and 29, the heating element is comprised of a resistance wire shaped into a coil having a first end 286(a) and a second end 286(b). It should be appreciated that the resistance wire can have additional forms and dimensions, and may be comprised of materials such as kanthal, nichrome, and nickel.

The heating element is in contact with a wick 295. The wick delivers the liquid vaporizing material to the heating element by capillary action. In the present embodiment, the heating element is coiled around the wick and is positioned inside the heating chamber 296. The wick protrudes outwardly through a pair of openings located on the heating chamber into opposite sides of the oil chamber for contact with the liquid vaporizing material contained therein. When electricity from a power source is applied, the heating element vaporizes the liquid vaporizing material. The wick may be comprised of any suitable material or combination of materials. Examples of suitable materials include cotton, twisted silica cord, ceramic, and stainless-steel mesh.

As different liquid vaporizing materials have different properties when used in different coils, in different wicks, and in different air flow configurations, part of the functionality and attraction of the present invention is that it includes interchangeable parts to enable users to modify the character of the vape pen 100 and experiment with various arrangements. For example, although many coil units use a cotton wick as their heating element, the user may prefer to use a coil unit containing a ceramic wick because it can withstand the high temperatures needed to vaporize cannabis oil without burning the material. Additionally, the use of interchangeable parts allows the user to clean and refill the oil chamber with a variety of liquid vaporizing materials by simply removing the coil unit from the coil unit compartment of the first housing.

A pair of first contacts 290 define a first contact surface positioned proximate to a second end 271 of the coil unit 255. The first contacts are configured for providing electrical communication between the heating element 285 and the power source externally located from the coil unit. In the present embodiment, each first contact 290 is wrapped by a sealing silicone sleeve 291(a), 291(b) and inserted into a first contact opening 293(a), 293(b). A first end 286 of the heating element 285 is in electrical communication with one of the first conductors 290 and a second end 287 of the heating element is in electrical communication with the other first conductor 290. Preferably, the first contacts 290 are highly conductive and temperature resistant and the heating element is highly resistive so that heat generation occurs primarily along the coils the heating element inside the heating chamber.

In another embodiment, as illustrated in FIGS. 45 and 46, the first housing 230 includes a first housing cover 232 that is configured to prevent dirt and debris from entering into the coil unit openings located on the bottom end of the coil unit and to increase the durability and general life span of the first housing and coil unit. In the present embodiment, the first housing cover 232 is made of silicone and comprises a hollow rectangular shaped body that is sized to fit snugly around the first housing 230. It should be appreciated that the first housing cover may be interchanged and may take additional forms, textures, ridges, and dimensions and may be formed from the same material as the mouthpiece cover or may be formed from another suitable material.

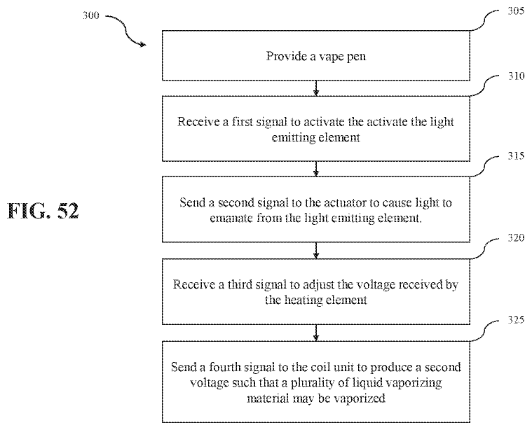

FIG. 52 is a flowchart describing the steps of the process 300 for illuminating vapor, according to an example embodiment of the present invention. The sequence of steps depicted is for illustrative purposes only and is not meant to limit the method in any way as it is understood that the steps may proceed in a different logical order, additional or intervening steps may be included, or described steps may be divided into multiple steps, without detracting from the invention. First, in step 305, the process includes providing a vape pen 100. As described above, the vape pen 100 includes a base unit 105 defining a rectangular box shape. The base unit 105 includes an integrally formed inner frame structure 113 and a corresponding inner frame cover 114 that is configured to securely house in electrical communication a central processing unit 120, a power source 125, a light emitting element 130, an actuator 135 for activating the light emitting element 130, a second pair of contacts 140 for engaging a first pair of contacts 290 of a pod 200, and a display 160. The base unit further includes a first end portion 106, a second end portion 107, a frontward facing surface 108, a rearward facing surface 109, and two opposing sidewalls 111(a), 111(b). The frontward facing surface 108 and the rearward facing surface 109 are configured to prevent dirt and debris from entering into the base unit and to increase the durability and general life span of the base unit. The vape pen 100 includes a chamber 114 at the second end portion 107 of the base unit. The chamber is configured for receiving a portion of the pod 200. The vape pen 100 also includes a charging port 115 at the first end portion 106 of the base unit 105. The charging port 115 is configured to recharge the power source 125 housed within the base unit 105. The vape pen 100 includes the central processing unit 120 containing the operating logic for the vape pen 100. As best illustrated in FIGS. 3 and 4, the central processing unit 120 is housed inside the base unit and conductively and communicatively coupled with the power source 125, the light emitting element 130, the actuator 135 for activating the light emitting element 130, the second contacts 140 for engaging the first contacts of the pod 155, and the display 160. The light emitting element 130 is housed inside the base unit 105. The light emitting element 130 is configured to emit at least one of a color and shade of light from the base unit. The actuator 135 is configured to allow the user to control how the various functions of the light emitting element are performed. The display 160 is configured to display a graphical representation of at least the various functions of the light emitting element, an amount of charge in the power source, and a voltage at which power is provided from the power source. The pod comprises a tube disposed within the pod, an oil chamber within pod for storing liquid vaporizing material, and a coil unit. The coil unit comprises a mouth at a first end portion of the coil unit, at least one coil unit passageway within the coil unit, a heating element, and a wick in contact with the heating element and positioned with a heating chamber.

Next, in step 310, the central processing unit 120 receives a first signal to activate the light emitting element. In step 315, the central processing unit 120 sends a second signal to the actuator to cause light to emanate from the light emitting element. The actuator 135 is configured to allow the user to control how the various functions of the light emitting element are performed. In operation, the actuator 135 may be depressed or pushed a predetermined number of times to adjust the light color, color-change sequence, color selection, color-change transition effects (fast fade, slow fade, etc.), color-change duration or speed, and flashing or strobe effects of the light emitting element. In step 320, the central processing unit 120 receives a third signal to adjust the voltage received by the heating element. In step 325, the central processing unit 120 sends a fourth signal to the coil unit to produce a second voltage such that a plurality of liquid vaporizing material may be vaporized. In operation, after the central processing unit 120 sends a fourth signal to the coil unit, the display will show a graphical representation of at least an amount of charge in the power source and a voltage at which power is provided from the power source.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

We claim:

1. A vape pen comprising:
a base unit defining a box shape;
a charging port at a first end portion of the base unit;
a chamber at a second end portion of the base unit, wherein the chamber is configured for receiving a portion of a pod;
wherein the pod has first contacts at a first end portion of the pod configured to be disposed within the second end portion of the base unit;
wherein the base unit is configured to house in electrical communication a central processing unit, a power source, a light emitting element, an actuator for activating the light emitting element, second contacts for engaging the first contact of the pod and a display;
wherein the light emitting element is positioned such that light is emitted from the second end portion of the base unit.

2. The vape pen of claim 1, wherein the pod comprising:
a tube disposed within the pod,
an oil chamber within pod, the oil chamber for storing liquid vaporizing material,
a coil unit comprising,
a mouth at a first end portion of the coil unit,
at least one coil unit passageway within the coil unit,
a heating element, and
a wick in contact with the heating element and positioned with a heating chamber.

3. The vape pen of claim 1, wherein the light emitting element is configured to emit at least one of a color and shade of light.

4. The vape pen of claim 1, wherein the light emitting element is configured to emit light to illuminate vapor proximate a user's mouth when in use by the user.

5. The vape pen of claim 1, wherein the vape pen is configured to allow the user to change between voltages so that a plurality of liquid vaporizing material may be vaporized.

6. The vape pen of claim 1, the display is configured to display a graphical representation of at least an amount of charge in the power source and a voltage at which power is provided from the power source.

7. A vape pen comprising:
a base unit defining a rectangular box shape;
a charging port at a first end portion of the base unit;
a chamber at a second end portion of the base unit, wherein the chamber is configured for receiving a portion of a pod;
wherein the pod has first contacts at a first end portion of the pod configured to be disposed within the second end portion of the base unit, a tube disposed within the pod, an oil chamber within pod, the oil chamber for storing liquid vaporizing material, a coil unit comprising a mouth at a first end portion of the coil unit, at least one coil unit passageway within the coil unit, a heating element, and a wick in contact with the heating element and positioned with a heating chamber;
wherein the base unit is configured to house in electrical communication a central processing unit, a power source, a light emitting element configured to emit light to illuminate vapor proximate to a user's mouth when in use by the user, an actuator for activating the light emitting element, second contacts for engaging the first contact of the pod and a display; and
wherein the light emitting element is positioned such that light is emitted from the second end portion of the base unit.

8. The vape pen of claim 7, wherein the light emitting element is configured to emit at least one of a color and shade of light.

9. The vape pen of claim 7, wherein the vape pen is configured to allow the user to change between voltages so that a plurality of liquid vaporizing material may be vaporized.

10. The vape pen of claim 7, the display is configured to display a graphical representation of at least an amount of charge in the power source and a voltage at which power is provided from the power source.

11. A method for illuminating vapor comprising:
a) providing a vape pen comprising,
a base unit defining a rectangular box shape;
a charging port at a first end portion of the base unit;
a chamber at a second end portion of the base unit, wherein the chamber is configured for receiving a portion of a pod;
wherein the pod has first contacts at a first end portion of the pod configured to be disposed within the second end portion of the base unit;
wherein the base unit is configured to house in electrical communication a central processing unit, a power source, a light emitting element, an actuator for activating the light emitting element, second contacts for engaging the first contact of the pod and a display;
wherein the light emitting element is positioned such that light is emitted from the second end portion of the base unit.
b) receiving a first signal to activate the light emitting element; and
c) sending a second signal to the actuator to cause light to emanate from the light emitting element.

12. The method of claim 11, wherein the pod comprises:
a tube disposed within the pod,
an oil chamber within pod, the oil chamber for storing liquid vaporizing material,
a coil unit comprising,
a mouth at a first end portion of the coil unit,
at least one coil unit passageway within the coil unit,
a heating element, and
a wick in contact with the heating element and positioned with a heating chamber.

13. The method of claim 11, wherein the method further includes emitting light in at least one of a color and shade of light.

14. The method of claim 11, wherein the method further includes emitting light that illuminates vapor proximate a user's mouth when in use by the user.

15. The method of claim 11, wherein the method further incudes:
receiving a third signal to adjust the voltage received by the heating element; and
producing a second voltage that is received by the coil unit so that a plurality of liquid vaporizing material may be vaporized.

16. The method of claim 11, wherein the method further includes displaying a graphical representation of at least an amount of charge in the power source and a voltage at which power is provided from the power source.
